(19) United States
(12) Patent Application Publication
(10) Pub. No.: US 2008/0035391 A1
(43) Pub. Date: Feb. 14, 2008

(54) Luggage rack with scale

(76) Inventors: Marie Jewett, Henderson, NV (US); Steve Jewett, Henderson, NV (US)

Correspondence Address: TOPE-MCKAY & ASSOCIATES, 23852 PACIFIC COAST HIGHWAY #311, MALIBU, CA, 90265, US

(21) Appl. No.: 11/503,552

(22) Filed: Aug. 11, 2006

(51) Int. Cl. G01G 21/00; G01G 19/52; B60R 11/00; B60R 9/00

(52) U.S. Cl. 177/126; 177/144; 224/497

(57) ABSTRACT

The present invention relates to a collapsible luggage rack with a built-in scale. The luggage rack is capable of weighing an item of luggage that is resting on the rack using a scale that is built into a weighing surface of the rack. A housing substantially encloses the scale and is supported by a collapsible frame that will fold alongside the housing into a compact, portable position for easy storage and transport. The scale provides a remote display of the weight that is easily visible while an item of luggage is resting on the rack. Additionally, the weighing surface of the scale is configured to measure the length and width of the item of luggage resting on the scale.

### BACKGROUND OF THE INVENTION

(1) Technical Field

The present invention relates to the field of supports and racks, and more specifically to the field of supports and racks with weighing scales.

(2) Background

Airlines and other forms of public transportation have long had restrictions on the size and weight of luggage that a passenger may check in or carry on when traveling. If a piece of luggage exceeds the weight limit posted by an airline, for example, the passenger must pay a surcharge to bring the luggage on the plane. Unfortunately, most passengers are unaware that a particular piece of luggage is overweight until that luggage is weighed at the airline check-in counter. To avoid a surcharge, the passenger is often forced to unpack at the check-in counter and frantically shuffle items from an overweight piece of luggage to an underweight piece. However, many passengers do not carry multiple pieces of luggage or purposely carry only one piece of luggage to the airport without thinking that that piece will be overweight.

If a traveler is able to plan ahead, the luggage can be weighed as soon as it is packed, before arriving at the airport, to avoid the hassle of unpacking at the airport. Current products available for this purpose include small handheld spring scales designed for the passenger to hold in the air while the piece of luggage being weighed is suspended from a hook underneath the scale. Although portable, the spring scale requires the passenger to lift the piece of luggage into by the spring scale handle. Most pieces of luggage that would warrant weighing exceed 50 pounds and could easily reach 100 pounds, making them difficult, if not impossible, for some passengers to lift. There is an additional risk of the traveler injuring himself or herself while attempting to lift the piece of luggage.

Other options for the traveler to weigh a piece of luggage are to use a typical floor scale generally designed for weighing people or to use a large utility floor scale that can handle a large piece of luggage and provide an accurate weight. However, typical floor scales used to weigh people are small in size and cannot properly support a piece of luggage. Large utility floor scales are heavy, expensive, and not widely available to the public.

Furthermore, airlines frequently change the weight requirements for luggage allowed on flights, and different airlines have different weight restrictions, which can lead to confusion when a user is trying to figure out how much a piece of luggage can weigh. Other than checking with each airline before traveling, there is no convenient way to determine the current weight restrictions for each airline.

Finally, airlines also restrict the size of luggage that can be carried on a plane and placed in an overhead bin or under a seat. Passengers are unable to determine if their luggage exceeds the size limitations until they arrive at the airport to place the luggage in a test bin.

Therefore, what is needed is a scale for weighing luggage that is easy to use, convenient for travelers, and capable of handling large pieces of luggage. What is additionally needed is a device to easily measure the size of a piece of luggage and provide updated information on luggage size and weight restrictions.

### SUMMARY OF THE INVENTION

The present invention provides an apparatus that overcomes the aforementioned limitations and fills the aforementioned needs by providing a collapsible luggage rack with a built-in scale for weighing luggage that is placed on a weighing surface. More specifically, the invention provides a housing that substantially encloses the scale that can be folded along with a collapsible frame into a folded position for easy storage and transport. The weighing surface can also include a measurement scale to measure the size of a piece of luggage.

In one embodiment, a collapsible rack with a scale comprises a scale configured to weigh an item, wherein the scale includes a weighing surface; a housing substantially surrounding the scale; and a collapsible frame connected with the housing for supporting the housing and scale, wherein the frame has a folded position and an unfolded position.

In another embodiment of the present invention, the collapsible rack with a scale further comprises a display of the weight of the item.

In still another embodiment of the present invention, the collapsible rack with a scale further comprises measurements on the weighing surface for a user to measure the item being weighed.

In yet another embodiment of the present invention, the housing is formed from a material selected from a group consisting of plastic, metal, or wood.

In a further embodiment of the present invention, the collapsible frame is formed from a material selected from a group consisting of plastic, metal and wood.

In another embodiment of the present invention, the collapsible rack with a scale further comprises a first support and a second support, wherein each support comprises two parallel legs extending from the housing to a supporting surface, and wherein the first support supports a first end of the housing and wherein the second support supports a second end of the housing.

In still another embodiment of the present invention, the parallel legs of the first support and second support extend from the housing to the supporting surface at an angle such that the legs of the first support are connected at an intersection with the legs of the second support to increase the structural support of the housing.

In yet another embodiment of the present invention, the first support is movably connected with the housing such that the first support can be moved from the first end of the housing to the second end of the housing, such that the first support and second support are connected with each other in a parallel configuration, and wherein the housing can be folded into parallel configuration with the first support and second support such that the collapsible rack with scale is in a folded position.

In a further embodiment of the present invention, the second end of the housing is connected with the second support of the collapsible frame using a movable hinged connection, and wherein the first end of the housing further comprises a hook to detachably attach the first support from the folded position to the unfolded position.

In another embodiment of the present invention, the collapsible rack with a scale further comprises a guide to aid the movement of the first support from the unfolded position to the folded position, and from the folded position to the unfolded position.

In still another embodiment of the present invention, the guide has a first end and a second end, and wherein the first end of the guide is connected with the first end of the housing and wherein the second end of the guide is connected with the second end of the housing.

In yet another embodiment of the present invention, the collapsible rack with a scale further comprises cross supports connecting the parallel legs of the first support and the parallel legs of the second support for added stability.

In still another embodiment of the present invention, the display is mounted on a cross support for easy viewing of the display during use.

In one embodiment of the present invention, a method of manufacturing a collapsible rack with a scale comprises the acts of: configuring a scale to weigh an item on a weighing surface; substantially surrounding the scale with a housing; and connecting the housing with a collapsible frame to support the housing and scale, wherein the frame has a folded position and an unfolded position.

In another embodiment of the present invention, the method further comprises the act of adding a display to display the weight of the item on the weighing surface.

In another embodiment of the present invention, the method further comprises the act of including measurements on the weighing surface of the scale for a user to measure the item being weighed.

In another embodiment of the present invention, the method further comprises the act of manufacturing the housing from a material selected from a group consisting of plastic, metal, or wood.

In another embodiment of the present invention, the method further comprises the act of manufacturing the collapsible frame from a material selected from a group consisting of plastic, metal, or wood.

### BRIEF DESCRIPTION OF THE DRAWNGS

The objects, features and advantages of the present invention will be apparent from the following detailed descriptions of the preferred aspect of the invention in conjunction with reference to the following drawings, where:

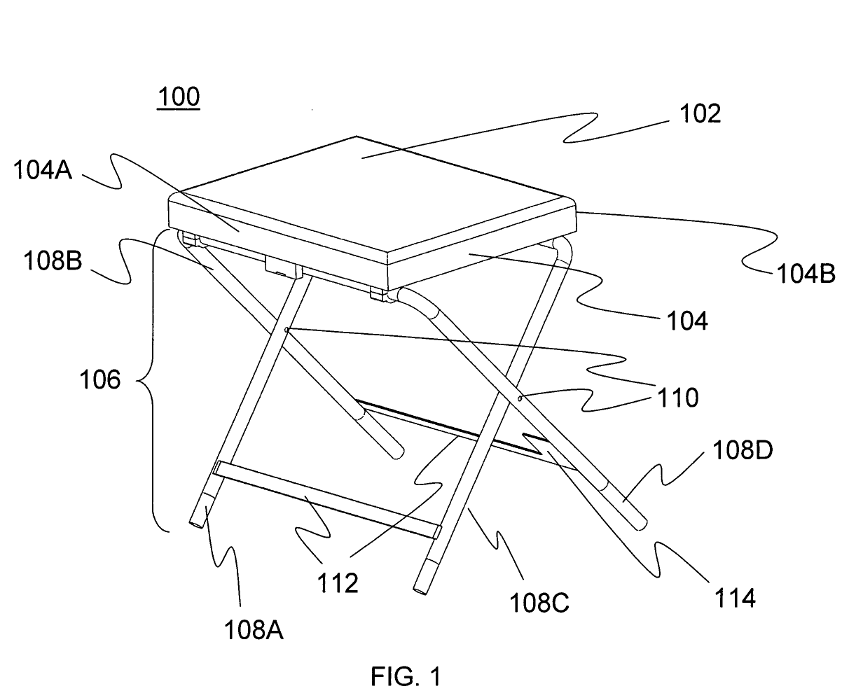

FIG. 1 is a perspective view of the luggage rack scale in an unfolded position including a weighing surface, housing, and collapsible frame;

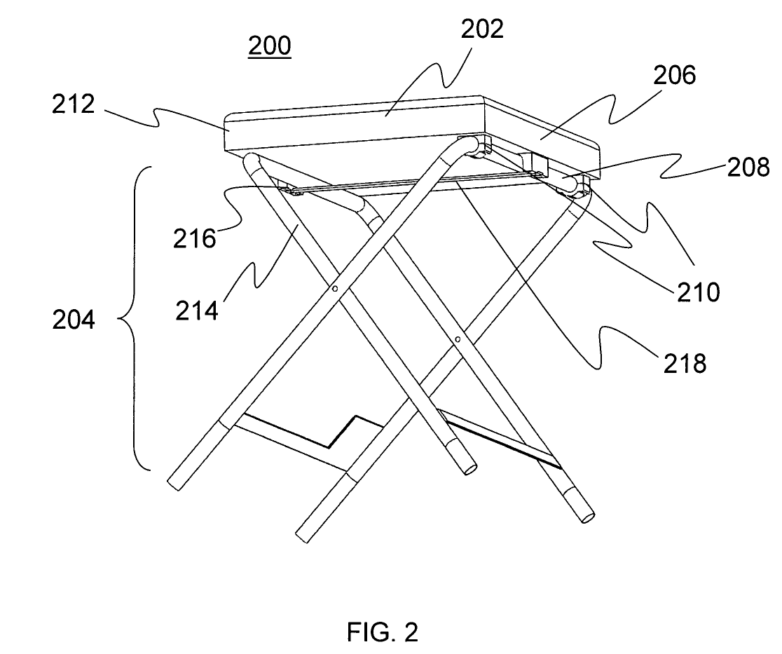

FIG. 2 is a perspective view of the luggage rack scale in an unfolded position including the weighing surface, housing, collapsible frame, and a guide;

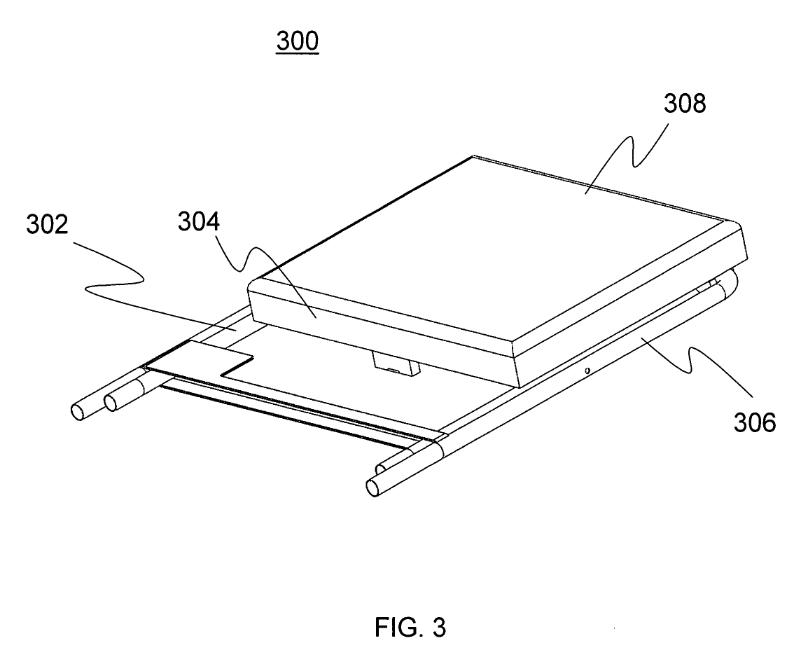

FIG. 3 is a perspective view of the luggage rack scale in a folded position including the housing, a fixed frame section and a movable frame section;

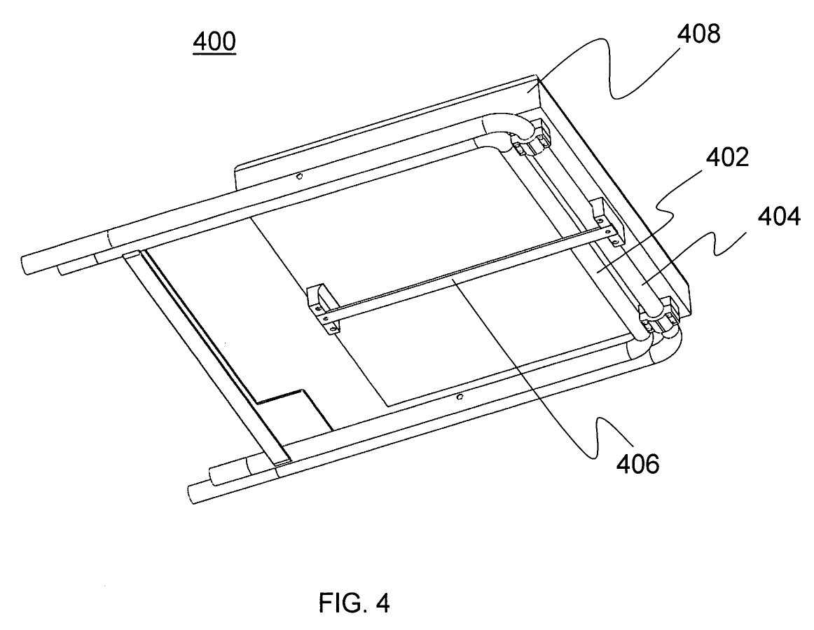

FIG. 4 is a perspective view of the luggage rack scale in a folded position specifically showing the movable frame section, fixed frame section, and guide.

### DETAILED DESCRIPTION

The present invention provides a luggage rack scale that can be used to store and access a piece of luggage while packing or unpacking with the added ability to weigh the piece of luggage at any point. The luggage rack scale is designed to collapse easily for storage and can similarly be quickly unfolded and used to weigh an item of luggage. The luggage rack scale is versatile in design and can be used as a rack or stand to support and weigh any object.

The following description, taken in conjunction with the referenced drawings, is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore it should be noted that, unless explicitly stated otherwise, the figures included herein are illustrated diagrammatically and without any specific scale, as they are provided as qualitative illustrations of the concept of the present invention.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6 and in particular, the use of “step of” in the claims herein is not intended to invoke the provisions of 35 U.S.C. Section 112, Paragraph 6.

The luggage rack scale provides a portable and convenient solution to the problem of weighing luggage before traveling on an airline or other luggage-restrictive public transportation means. The luggage rack scale can be collapsed into a relatively flat piece without removing the scale or any other component, such that the product can be stored out of sight when not in use or carried easily from one place to another. Once unfolded, the luggage rack scale can simply act as a stand to support or weigh any object in addition to luggage.

In one embodiment of the luggage rack scale showing the luggage rack scale in an unfolded position, as depicted in FIG. 1, the luggage rack scale 100 comprises a weighing surface 102 for placing an object to be weighed, a housing 104 that contains the scale (scale not pictured), and a collapsible frame 106 to support the housing 104. The frame 106 further comprises four legs 108A and 108B and 108C and 108D, which extend from the housing 104 to the ground at an angle such that the pair of legs 108B and 108D supporting a first end of the housing 104A touch the ground below a second end of the housing 104B. In the same way, the legs 108A, 108C supporting the second end of the housing 104B reach the ground below the first end of the housing 104A. In this way, the legs 108A and 108B and 108C and 108D form an “X” shape as they extend from the housing 104 to the ground. The angle of the legs 108A and 108B and 108C and 108D provide added stability for the luggage rack scale 100 to handle heavy loads without tipping over. At the intersection 110 of the legs 108A and 108B and 108C and 108D, the legs 108A and 108B and 108C and 108D are rotatably connected to allow the legs 108A and 108B and 108C and 108D to move from a folded position into an unfolded position. The frame 106 is further stabilized by a pair of cross supports 112 that attach a lower portion of leg 108A to leg 108C and a lower portion of leg 108B to leg 108D.

One skilled in the art will appreciate that the platform, housing and frame can be made from any hard material such as plastic, a metal such as aluminum, or wood. In the embodiment described in FIG. 1, the frame is aluminum tubing and the platform is a durable, molded plastic.

In another embodiment, the weighing surface 102 contains measurements along the edges of the weighing surface 102 to help a user determine the length and width of the item to be weighed. This feature is particularly useful to airline passengers who must not only weigh luggage but also measure the luggage if they wish to carry it on the plane with them. An alternative embodiment provides for a retractable measuring tape to be extended beyond the length of the platform in the event the luggage is longer or wider than the existing platform surface.

A display 114 on the luggage rack scale 100 provides the measured weight of the item on the scale so that a user can easily see it with a large item on the scale. The scale (not pictured) will have a wire running through one of the legs to an LED display 114 to communicate the weight of the object on the scale. If the LED display 114 is mounted on one of the cross supports 112, it can be easily read by a user without worrying about the size of the item on the scale obstructing the display.

One skilled in the art will appreciate that the design of the platform will vary depending on the type of scale used below the platform. In another embodiment, the platform is built-in to the scale and is not a separate piece attached to the scale. In still another embodiment, the platform is shaped like a tray, with high edges around all sides to create a cavity in the tray. The scale is then mounted inside the tray such that an upper weighing surface of the scale is flush with the edges of the tray, creating a flat surface for placing an item to be stored or weighed.

Furthermore, in yet another embodiment of the present invention, the platform will contain a small sleeve (not pictured) for holding a placard indicating the weight and size restrictions of various transportation companies. The placard can be removed from the sleeve when it becomes outdated and replaced with an updated list.

FIG. 2 illustrates a bottom-up perspective view of one embodiment of the luggage rack scale 200, depicting the connection mechanism of the housing 202 and the collapsible frame 204. On a first end of the housing 206, a fixed frame section 208 is attached with several latches 210 that rotatably connect the housing 202 with the fixed frame section 208. The rotatable connection allows the housing 202 to rotate from an unfolded position as shown in FIG. 2 to a folded position depicted in FIG. 3. On a second end of the housing 212, a movable frame section 214 is detachably attached with the housing 202 using a latch mechanism 216. The detachable latch mechanism 216 further facilitates the ease of transitioning the luggage rack scale 200 from the unfolded position to the folded position. The frame 204 further comprises a guide 218 which connects the fixed frame section 208 to the movable frame section 214. During the folding of the luggage rack scale 200 from the unfolded position to the folded position (see FIG. 3), the movable frame section 214 is released from the detachable latch mechanism 216 and moved toward the fixed frame section 208. The guide 218 prevents the movable frame section 214 from moving away from the housing and keeps the folding action uniform and steady.

FIG. 3 illustrates one embodiment of the luggage rack scale 300 in a folded position. Once the movable frame section 302 is moved from the first end of the housing 304 toward the fixed frame section 306 and second end of the housing 308, the housing 304 can be folded down alongside the collapsed frame sections so that the luggage rack 300 scale is small, compact, and easy to move and store for later use. The movable frame section 302 and fixed frame section 306 are formed such that the moveable frame section 302 will fit inside the form of the fixed frame section 306 to create a compact shape.

FIG. 4 depicts a bottom view of the luggage rack scale 400 in the folded position. As can be more clearly seen, the movable frame section 402 fits inside the shape of the fixed frame section 404 to create a flat, easily movable form. The guide 406 maintains the frame sections 402 and 404 in the flat form alongside the housing 408 so that the luggage rack scale 400 is easy to move.

What is claimed is:

1. A collapsible rack with a scale comprising:
a scale configured to weigh an item, wherein the scale includes a weighing surface;
a housing substantially surrounding the scale; and
a collapsible frame connected with the housing for supporting the housing and scale, wherein the frame has a folded position and an unfolded position.

2. The collapsible rack with a scale of claim 1, further comprising a display of the weight of the item.

3. The collapsible rack with a scale of claim 1, further comprising measurements on the weighing surface for a user to measure the item being weighed.

4. The collapsible rack with a scale of claim 1, wherein the housing is formed from a material selected from a group consisting of plastic, metal, or wood.

5. The collapsible rack with a scale of claim 1, wherein the collapsible frame is formed from a material selected from a group consisting of plastic, metal and wood.

6. The collapsible frame of claim 1, further comprising a first support and a second support, wherein each support comprises two parallel legs extending from the housing to a supporting surface, and wherein the first support supports a first end of the housing and wherein the second support supports a second end of the housing.

7. The collapsible frame of claim 6, wherein the parallel legs of the first support and second support extend from the housing to the supporting surface at an angle such that the legs of the first support are connected at an intersection with the legs of the second support to increase the structural support of the housing.

8. The collapsible frame of claim 7, wherein the first support is movably connected with the housing such that the first support can be moved from the first end of the housing to the second end of the housing, such that the first support and second support are connected with each other in a parallel configuration, and wherein the housing can be folded into parallel configuration with the first support and second support such that the collapsible rack with scale is in a folded position.

9. The collapsible rack with a scale of claim 8, wherein the second end of the housing is connected with the second support of the collapsible frame using a movable hinged connection, and wherein the first end of the housing further comprises a hook to detachably attach the first support from the folded position to the unfolded position.

10. The collapsible rack with a scale of claim 9, further comprising a guide to aid the movement of the first support from the unfolded position to the folded position, and from the folded position to the unfolded position.

11. The collapsible rack with a scale of claim 10, wherein the guide has a first end and a second end, and wherein the first end of the guide is connected with the first end of the housing and wherein the second end of the guide is connected with the second end of the housing.

12. The collapsible rack with a scale of claim 6, further comprising cross supports connecting the parallel legs of the first support and the parallel legs of the second support for added stability.

13. The collapsible rack with a scale of claim 12, wherein the display is mounted on a cross support for easy viewing of the display during use.

14. A method of manufacturing a collapsible rack with a scale, the method comprising the acts of:
configuring a scale to weigh an item on a weighing surface;
substantially surrounding the scale with a housing; and
connecting the housing with a collapsible frame to support the housing and scale, wherein the frame has a folded position and an unfolded position.

15. The method of claim 14, further comprising the act of adding a display to display the weight of the item on the weighing surface.

16. The method of claim 14, further comprising the act of including measurements on the weighing surface of the scale for a user to measure the item being weighed.

17. The method of claim 14, further comprising the act of manufacturing the housing from a material selected from a group consisting of plastic, metal, or wood.

18. The method of claim 14, further comprising the act of manufacturing the collapsible frame from a material selected from a group consisting of plastic, metal, or wood.
